(19) United States
(12) Patent Application Publication
(10) Pub. No.: US 2016/0295089 A1
(43) Pub. Date: Oct. 6, 2016

(54) VEHICLE-BASED CLOUD-AWARE VIDEO CAPTURE SYSTEM

(71) Applicant: Ali Farahani, Glendale, CA (US)

(72) Inventor: Ali Farahani, Glendale, CA (US)

(21) Appl. No.: 14/673,606

(22) Filed: Mar. 30, 2015

(51) Int. Cl. H04N 5/232; H04N 5/247; B60R 11/04; H04N 7/18

(52) U.S. Cl. CPC H04N 5/23203; H04N 7/181; H04N 5/23216; H04N 5/247; B60R 11/04; B60R 2011/004

(57) ABSTRACT

Systems are provided for capturing video images from vehicles and relaying the video to a cloud-based database for access by authorized users. In one example, a video capture apparatus is conveniently mounted to a dashboard power socket of a vehicle. The apparatus includes adjustable arms for positioning a videocamera above the dashboard to capture video of the road ahead of the vehicle. A controller device transmits the video along with the date/time and location of the vehicle to a database of the cloud-based system using cellular, Wi-Fi or other communication networks. Thereafter, authorized users such as insurance investigators or law enforcement personnel can search the database to locate videos relevant to accident investigations or criminal matters, such as videos that recorded the scene of an accident or street crime. A fee may be automatically paid to the owner of the vehicle for access to video obtained from that vehicle.

### BACKGROUND

1. Field of the Invention

Aspects of the invention relate to video capture systems for use in vehicles and to cloud-based systems for processing and accessing video obtained from vehicles.

2. Description of Related Art

Video capture devices may be mounted to the dashboards of vehicles for capturing video of the road ahead of the vehicle. These devices are often employed by drivers to continuously record ongoing video so that, should the driver be in an accident, the video can be used to prove the innocence of the driver (assuming he or she was not at fault). Typically, a small off-the-shelf dashboard video camera—referred to as a “dashcam”—is mounted to or otherwise placed on the dashboard of the vehicle to capture the video. Dashcams can consume a fair amount of power and so the dashcam is often connected into a socket charger of the vehicle (e.g. a dashboard cigarette lighter) using a standard power cable. In practice, this can be a very inconvenient arrangement. The power cable may be too long and excess length of the loose cable may spool below the dashboard, possibly interfering with the brake and accelerator petal. Even if the cable is of proper length, it can interfere with access to dashboard controls or otherwise present a distraction or nuisance to the driver. Moreover, if not properly and securely mounted, dashcams may slide off the dashboard while the vehicle is in motion, posing a danger or distraction.

Still further, the driver may need to remember to activate the dashcam before driving and, if the driver forgets, no video is recorded. A standard off-the-shelf dashcam may have fairly limited storage for recording video and hence may capture only the last couple of hours of driving. However, in some cases it may be desirable to examine a much longer interval of video, such as if law enforcement officials seek to use dashcam video to identify a vehicle that drivers may have passed earlier in the day. Moreover, in an accident, the dashcam and its storage device may be destroyed on impact so that the video is lost. This can be especially frustrating to the driver if he or she is thereby unable to establish innocence in an automobile accident and can be quite expensive for the insurance carrier of the driver, which might need to satisfy unjust and potentially fraudulent claims. Accordingly, it would be desirable to provide improved video capture devices and systems for mounting within vehicles that address these and other concerns and some aspects of the invention are directed to these ends.

As noted, law enforcement officials may seek to examine video obtained by dashcams over an extended period of time, even in circumstances where no accident occurred. In one example, law enforcement may seek to examine the dashcam video obtained from all vehicles driven along a particular street where a crime occurred in an effort to identify a suspect fleeing the scene of a crime. This may require looking back over many hours of video, perhaps over a period of days. However, given the limited storage of typical dashcams, that video may no longer be available since it will already have been automatically overwritten. Hence, a system capable of storing longer intervals of video than typically recorded by dashcams would be quite advantageous. In any case, the cost and logistics of obtaining dashcam video from numerous vehicles or from many different drivers may be prohibitive. Accordingly, it would also be desirable to provide a system for collecting and collating dashcam video from many drivers or vehicles for ease of access by law enforcement and other aspects of the invention are directed to these ends.

Insofar as insurance companies are concerned, such a video collection system would be of particular value since the insurance company, upon receiving a claim to damages in an accident, could then access the system to obtain any and all video recorded at the scene of an accident by all passing vehicles, even video from vehicles not directly involved in the accident. Indeed, as noted, the dashcams of vehicles in accidents may be destroyed on impact and their video lost. Hence, the only available video may come from other passing vehicles whose drivers may have left the scene of the accident before their video could be saved by the victims of the accident or by authorities responding to the accident. Accordingly, it also would be desirable to provide a system for collecting and collating dashcam video from many drivers or vehicles for ease of access by insurance investigators and still other aspects of the invention are directed to these ends. Development of an equitable and efficient system for subsidizing such a system would also be advantageous and still further aspects of the invention are directed to that end.

### SUMMARY

In an exemplary embodiment, an apparatus for use with a vehicle includes: a videocamera for obtaining images; a power connector to connect into a vehicle power source; an arm for selectively positioning the videocamera and for connecting the videocamera to the power connector; and a controller mounted along the arm to control operations of the videocamera and to relay power from the power connector to the videocamera.

In an illustrative embodiment of the apparatus, the power connector is adapted to connect into one or more of a socket charger power source or a Universal Serial Bus (USB) power source. The arm is adapted to selectively position the videocamera with a view of at least some of the surroundings of the vehicle. Two or more arms may be provided. The controller is further operative to obtain images from the videocamera(s) and output the images to a system external to the vehicle using one or more of Bluetooth™; Wi-Fi; 3G wireless; and/or 4G wireless. The controller is further operative to obtain audio signals and output the audio signals to a system external to the vehicle. The controller can also store at least a portion of the images obtained from the videocamera for subsequent output to an external system. The controller may include a port for receiving one or more of a memory card, a Universal Serial Bus (USB) device or a flash storage device. The controller is also adapted to be tethered to at least one wireless device positioned on or within the vehicle. The apparatus may include a Global Positioning System (GPS) device for tracking the location of the vehicle. The apparatus is adapted for use in one or more of a car, truck, aircraft, watercraft, drone, train or motorcycle.

Still further, in the illustrative embodiment, the controller compresses at least a portion of the images while distinguishing objects of interest from other objects. The controller is further operative to obtain additional images from one or more other videocameras mounted on or in the vehicle and/or to obtain information from an on-board computer of the vehicle. In some examples, two or more videocameras are provided. The aforementioned arm may be detachably connected to the controller. The controller may also be operative to control the output of images upon detection of one or more of an impact involving the vehicle, a predicted impact involving the vehicle and an unauthorized access to the vehicle.

In another exemplary embodiment, a system for providing access to images from a plurality of vehicles includes: an input system for inputting images obtained by videocameras within a plurality of vehicles along with identifying information associated with the images that identifies, for each image or group of images, where the images were obtained, when the images were obtained and an originator of the images; a storage system for storing the identifying information; and an access system for allowing selective access to the stored images by an authorized party based on at least some of the identifying information and subject to an access fee, wherein a portion of the access fee is forwarded to the originator associated with the accessed images.

In an illustrative embodiment of the system for providing access to images, the authorized party is one or more of an insurance company or a law enforcement agency. The originator is associated with a particular vehicle from which accessed images were obtained or is associated with a particular videocamera apparatus used to obtain the accessed images. The access system includes a search system allowing the authorized party to search for images based on one or more of time, location or originator. The access system may also include a search system allowing the authorized party to search for images based on the content of the images such as one or more of individual faces, individual vehicles or individual license plates recorded in the images. At least some of the images stored in the system are videos streamed from a vehicle.

System and method examples are described in detail below.

### BRIEF DESCRIPTION OF THE DRAWINGS

Referring now to the drawings in which like reference numbers represent corresponding parts throughout and in which:

FIG. 1 provides an overview of an exemplary vehicle-based cloud-aware video capture system with selected features represented stylistically or schematically;

FIG. 2 provides a stylized illustration of the dashboard of a vehicle with a video capture apparatus mounted thereto;

FIG. 3 illustrates selected functional components of the exemplary vehicle-based cloud-aware video capture system of FIG. 1;

FIG. 4 illustrates selected components of an exemplary cloud-based data record storage system for use with the system of FIG. 1;

FIG. 5 illustrates additional functional components of an exemplary vehicle-based cloud-aware video capture system for use with vehicles equipped with on-board integrated sensors and computing systems;

FIG. 6 provides a stylistic top view of a vehicle equipped with on-board integrated sensing and computing systems;

FIG. 7 illustrates an exemplary procedure performed by an apparatus or system mounted within a vehicle for use in managing the uploading of video images and other data to a cloud-based access/storage system;

FIG. 8 illustrates an exemplary procedure performed by cloud-based components for allowing or managing access to video images and other data stored within the cloud-based access/storage system by authorized users;

FIG. 9 illustrates an exemplary procedure performed by an apparatus or system mounted within a vehicle for controlling uploading of video images and other data to a cloud-based access/storage system in the event of a vehicle impact or other emergency;

FIG. 10 illustrates an exemplary procedure performed by an apparatus or system mounted within a vehicle for controlling uploading of video images and other data to a cloud-based access/storage system in the event of a vehicle break-in or other unauthorized access attempt to the vehicle;

FIG. 11 illustrates an exemplary video capture apparatus for mounting within a vehicle, wherein the apparatus has adjustable and extensible arms;

FIG. 12 illustrates another exemplary video capture apparatus for mounting within a vehicle, wherein the apparatus is equipped to mount two videocameras;

FIG. 13 illustrates yet another exemplary video capture apparatus for mounting within a vehicle, wherein the apparatus includes a ball-and-socket upper arm and a folding lower arm;

FIG. 14 provides an overview of various vehicles that may provide video and other data for use with the cloud-aware video capture system;

FIG. 15 summarizes selected features of a video capture apparatus for mounting within a vehicle;

FIG. 16 summarizes a procedure for use with the video capture apparatus of FIG. 15 or other suitably-equipped systems, devices or apparatus;

FIG. 17 summarizes selected features of a system for providing access to images obtained from a plurality of vehicles;

FIG. 18 summarizes a procedure for use with the system of FIG. 17 or other suitably-equipped systems, devices or apparatus;

FIG. 19 summarizes a procedure for selectively compressing images obtained from a videocamera mounted on or within a vehicle; and

FIG. 20 summarizes a procedure for searching for images obtained from a videocamera mounted on or within a vehicle based on various parameters.

### DETAILED DESCRIPTION OF ILLUSTRATED EMBODIMENTS

In the following descriptions, specific details are given to provide a thorough understanding of the various aspects of the disclosure. However, it will be understood by one of ordinary skill in the art that the aspects may be practiced without these specific details. The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Exemplary Vehicle-Based Cloud-Aware Video Capture Systems and Components

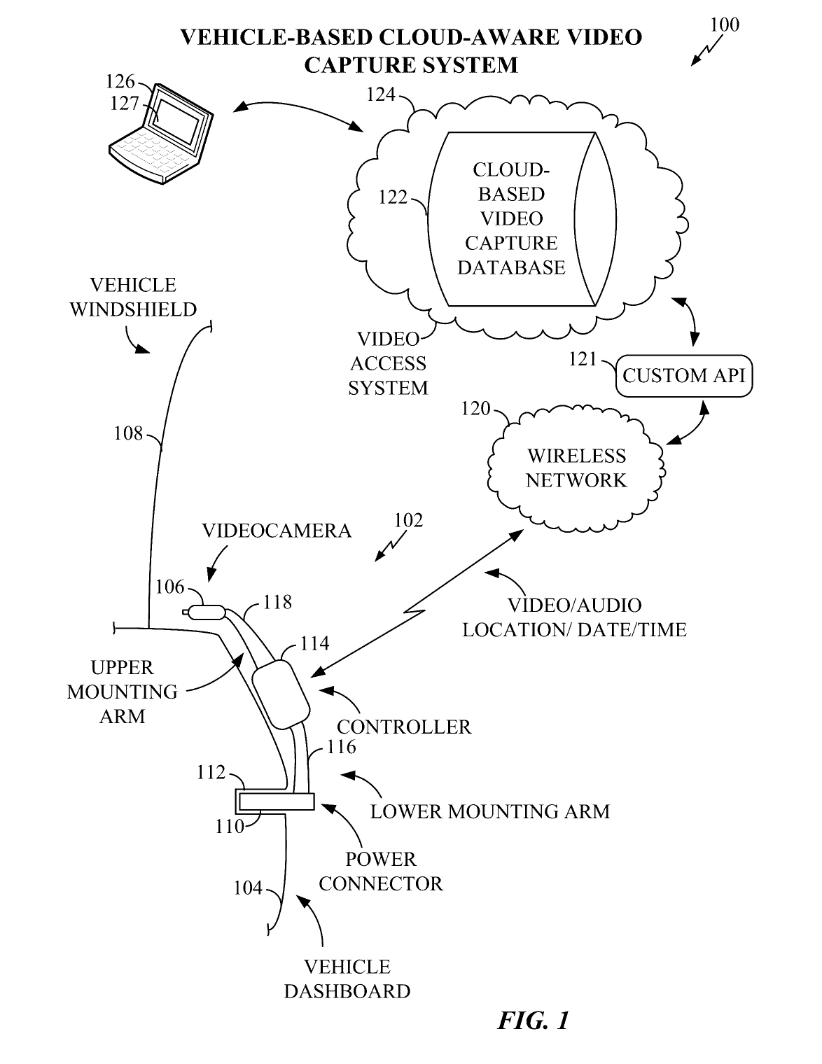

FIG. 1 provides an overview of an exemplary vehicle-based cloud-aware video capture system 100. In the exemplary system, “cloud” generally refers to systems that exploit groups of remote servers and software networks to allow for centralized data storage and online access to computer services or resources. Also, in the exemplary system, “cloud-aware” generally means that the system exploits or is capable of exploiting cloud-based computing or cloud-based data storage services. Still further, in the exemplary system, “vehicle-based” generally means that the system processes data (such as videos) obtained by devices mounted on or within a vehicle or otherwise associated with vehicles.

As shown in FIG. 1, exemplary system 100 includes a video capture apparatus 102 for mounting adjacent a dashboard 104 of a vehicle such as a car or truck. The video capture apparatus includes, in this example, a videocamera 106 for capturing images through a front windshield 108 of the vehicle. Power to operate the videocamera is obtained from the electrical system of the vehicle using a power connector plug 110, which is plugged or otherwise mounted into a socket charger power source 112 (i.e. a cigarette lighter) or other suitable power source such as a Universal Serial Bus (USB) connector. In the example of FIG. 1, power source 112 is provided within a vertical portion of the dashboard of the vehicle. However, in other examples, the power source might be provided elsewhere in the vehicle, such as within a central control console on the floor of the front of the vehicle between the front seats. In any case, power obtained from the power source is routed by a device controller 114 through power cables or wires (not shown in FIG. 1) within a lower mounting arm 116 and an upper mounting arm 118 into videocamera 106. In some examples, the videocamera may have its own battery power source (not shown in FIG. 1) for use as a secondary or backup power source in the event power from the vehicle power source is interrupted. Still further, controller 114 may have an additional battery power source (also not shown) for use as a secondary or backup power source. However, in the example of FIG. 1, it is preferred that power is drawn from the vehicle power source while the vehicle is operating so as to provide an abundant source of power to permit recordation of many hours of video, which might not otherwise be feasible if relying on batteries within the videocamera itself or within the controller.

In the example of FIG. 1, both upper and lower arms 116 and 118 are adjustable through various ranges of motion (e.g. pivotable, bendable, extensible, etc.) and yet are sufficiently rigid and sturdy to hold the controller and videocamera substantially steady while driving to prevent undue wobble of the videocamera. Exemplary arm designs will be discussed in greater detail below. Since the arms are adjustable, the videocamera can be conveniently positioned above the dashboard to capture a clear view of the road ahead of the vehicle and yet without interfering with the view of the driver or passengers. For smaller vehicles, the arms may be retracted so that the videocamera is not positioned too high. For trucks and larger vehicles, the arms may be extended as needed. Since power is delivered via power cables within the arms 116 and 118, no separate cables or wires are required, which might otherwise be an annoyance or hindrance to the driver or passengers.

In addition to routing power to the videocamera, controller 114 controls the operation of the videocamera and (at least temporarily) records video received from the videocamera via connection lines (not shown in FIG. 1) within upper arm 118. Depending upon device programming, video obtained by controller 114 from videocamera 106 is streamed (i.e. transmitted substantially in real-time) from the controller to a wireless communications network 120 via suitable wireless or cellular communication protocols such as 3G or 4G (i.e. Third Generation or Fourth Generation wireless technologies as denoted by the International Telecommunication Union) or via Wi-Fi (e.g. 802.11), if available. The transmission of the data is managed by the device controller so as to reduce or minimize transmission costs, especially when employing a cellular network. For example, the rate of transmission of data may be intelligently managed to control cost. The wireless network relays the video—as well as corresponding audio (if recorded), the data/time and the location of the vehicle—to a cloud-based video capture database 122 via a custom Application Programming Interface (API) 121. In some examples, all communications with the cloud-based system use Transport Layer Security (TLS). The video capture database is part of a cloud-based video storage/access system 124, which grants access to the video and other data by authorized users via browsers or applications (i.e. apps) installed within computer access devices 126 such as browser/app 127 displayed on the exemplary laptop computer of FIG. 1. Other computer access devices may, of course, be employed such as desktop computers, tablet computers, mobile devices, etc. The various cloud-based components may be implemented using, e.g., Microsoft Azure™ or Amazon Web Service (AWS)™ or other systems that support API or browser-based (i.e. web-based) access for authorized users. Open API is typically preferred.

The video/audio data obtained from video capture apparatus 102 is stored along with videos obtained from other video capture devices installed in other vehicles (as well as, in at least some examples, video obtained from videocameras integrated into vehicles such as backup cameras). In this manner, authorized personnel—such as law enforcement or insurance investigators—may conveniently access selected videos recorded within database 122 to, for example, ascertain the identity of those at fault in accidents or the like. As will be explained in greater detail below, investigators may search for videos obtained from any and all vehicles that happened to be at the scene of an accident (based on the time and location of the accident) so as to find videos that may have captured the accident and which may thereby reveal the identity of the driver at fault. Notably, this may include video from vehicles that were not involved in the accident and yet which may have passed the scene of the accident and captured video of the accident. In other examples, investigators may perform such searches based on the time and location of crimes in an effort to identify the perpetrators of the crimes and/or to track the location of victims, etc.

In various examples described herein, whenever investigators access videos obtained from a particular vehicle, the investigating agency pays a fee for that access and a portion of the access fee is automatically paid to the owner of the video capture device 102 that provided the video (or to the owner or lessee of the vehicle, if appropriate). This will help encourage drivers to participate in the cloud-based system and defray the cost of purchasing the video capture apparatus and uploading video data to the cloud-based database. Still further, it is anticipated that many insurance companies will wish to encourage the use of video capture apparatus 102 or similar devices by subsidizing the cost of such devices (and any wireless connection fees, etc.) since the insurance companies may then be able to substantially reduce payments made on fraudulent insurance claims by using the system to ascertain the identity of those truly at fault in an accident. For example, insurance companies may wish to provide a significant reduction in the insurance premium of drivers willing to purchase a video capture apparatus and upload steaming video. Not only will the video potentially allow insurance companies to avoid payments on fraudulent claims, but any driver participating in the system should be expected to drive carefully and cautiously to avoid accidents in which he or she might be found at fault, further benefiting the insurance companies. Likewise, state law enforcement agencies and driver licensing bureaus (i.e. DMVs) may wish to provide a reduction in driver licensing fees, vehicle registration fees or the like for drivers willing to purchase the video capture apparatus and upload steaming video. As noted, this encourages careful and cautious driving, which is in the best interests of the state for numerous reasons, including reducing emergency room and other medical costs (which might not be reimbursed to the state if the drivers and victims are not fully and properly insured).

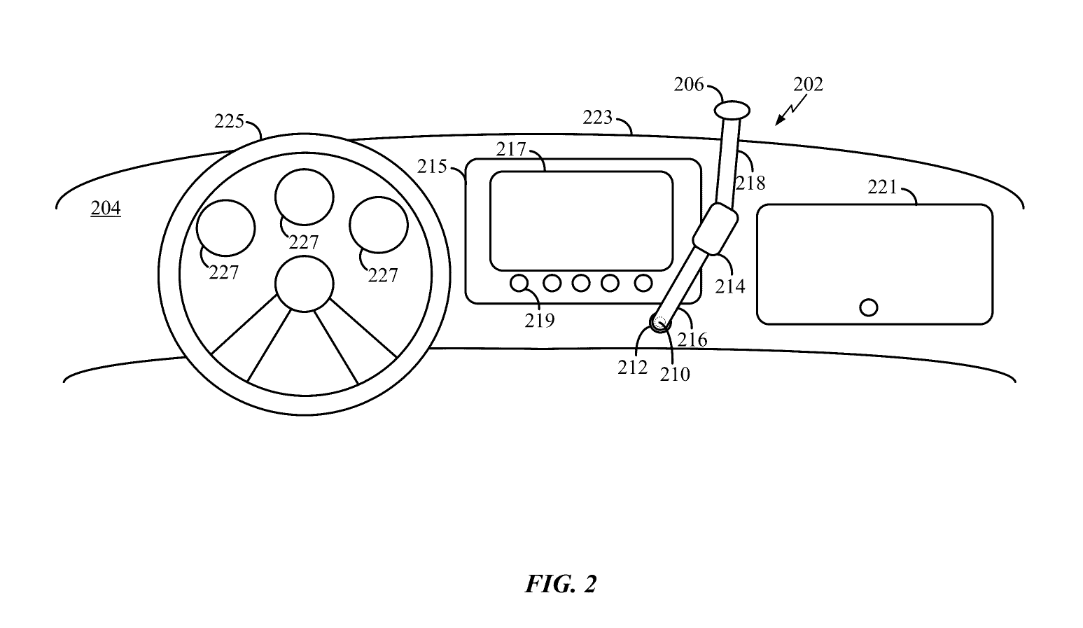

FIG. 2 provides a stylized illustration of the dashboard 204 of a vehicle with a video capture apparatus 202 mounted thereto, with the view of FIG. 2 illustrating an exemplary orientation of the apparatus relative to the components of the dashboard. In this example, power connector 210 of the apparatus is mounted into a socket charger power source 212 installed below a central dashboard control console 215 that includes a navigation display screen 217 and various controls 219. The adjustable lower and upper arms 216 and 218 of apparatus 202 allow controller 214 of the apparatus to be conveniently positioned so as not to obstruct the view of, nor interfere with access to, the central console 215 and the glove compartment 221 while also allowing the videocamera 206 to be mounted above a top surface 223 of the dashboard to provide an unobstructed view of the road ahead. Note that, with this apparatus, no loose cables are used to connect the videocamera to the power socket of the dashboard as typically required with standard dashcams. As noted above, such loose cables can interfere with access to dashboard controls or otherwise present an annoyance to the driver and passengers. FIG. 2 also shows a steering wheel 225 and various gauges 227, such as speedometers, tachometers and the like. If a conventional dashcam were instead mounted by the driver to the top left of the dashboard, its power cable might interfere with the steering wheel and/or block the view of the gauges, or perhaps block the view of the navigation screen.

Hence, FIGS. 1 and 2 provide illustrative examples of the location and orientation of an exemplary video capture apparatus. In practice, the location and orientation of the apparatus may depend upon the location of the power source(s) of the vehicle, as well as the location and orientation of various dashboard components. For vehicles adapted for driving on the left side of the road, rather than the right, it may be more convenient to mount the video capture apparatus on the left side of the dashboard. For vehicles where the power socket is provided within a floor-mounted console rather than a dashboard console, the arms of the video capture apparatus may need to be extended more fully to permit the videocamera to be positioned above the top of the dashboard. Within any vehicle in which the power source is too far from the top of the dashboard (or which otherwise prevents convenient positioning of the video capture apparatus), the lower arm of the video capture apparatus can instead be mounted to any suitable location along the dashboard using a clamp or other device and with an extension cable employed to connect the lower arm to the vehicle power source. Although this configuration may not be as preferable as one in which the lower arm is plugged directly into a dashboard-mounted power socket, it is still preferable to the use of a standard dashcam where the power cable would dangle from the top of the dashboard.

Insofar as the physical connection of the power connector of the apparatus into the power socket of the vehicle is concerned, the power connector plug of the apparatus is preferably configured to provide a tight connection into the power socket so as to prevent the lower arm of the apparatus from rotating within the socket or jarring free of the socket. This may be achieved, for example, by providing the power connector plug of the lower arm of the apparatus with negative power contacts that are thicker, sturdier and less flexible than those of conventional power socket plugs. (The negative power contacts of a power plug for use in a vehicle power socket typically are flexible and extend outwardly from side portions of a plug to hold the plug in the power socket and provide the negative electrical contact to complete the circuit to allow the plug to draw power from the socket.) Additionally or alternatively, the arms of the video capture apparatus may be provided with any suitable mechanisms to keep the power connector plug securely mounted within the power socket and/or to help hold the apparatus to the dashboard of the vehicle to prevent undue movement of the apparatus, such as clamps, suction cups or the like.

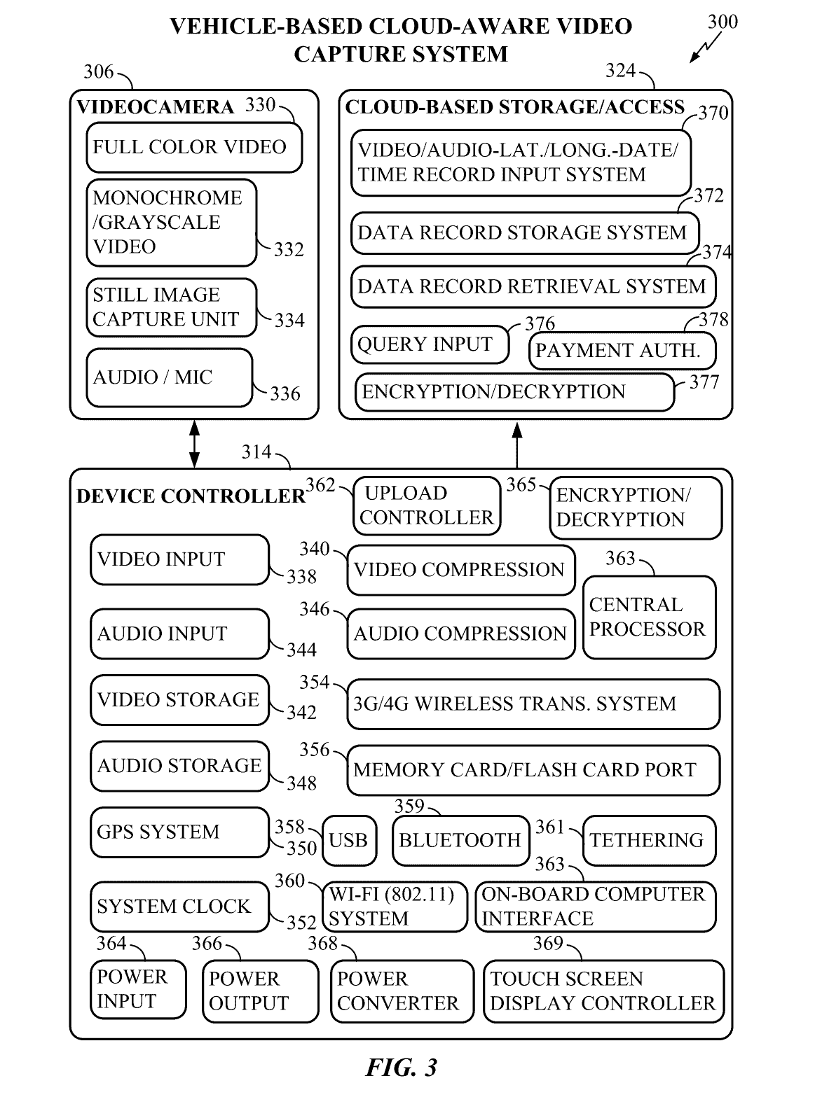

Turning now to FIG. 3, various functional components of an exemplary vehicle-based cloud-aware video capture system will now be described. In the example of FIG. 3, a system 300 is illustrated that includes a videocamera 306, a device controller 314 and a cloud-based storage/access system 324. The videocamera includes one or more of a full color video component 330, a monochrome and/or grayscale video component 332 and/or a still image capture component 334. In practice, the videocamera will typically include only one of these components but all three are shown for the sake of completeness. Any or all of these components may be, for example, high definition (HD) components. The still image capture unit may be programmed, e.g., to capture one still image every five or ten seconds. As can be appreciated, the amount of data to be transmitted and stored when using the still image capture unit is significantly less then when using full HD video or monochrome/grayscale HD video and hence may be preferred by some users. That is, the bandwidth required for full color HD video is far greater than the bandwidth required for still images. In some cases, monochrome/grayscale may provide a useful compromise between the visual fidelity of HD full color video (which requires greater bandwidth) and the periodic capture of still images (which requires less bandwidth), and hence may be preferred for some applications. In some examples, the videocamera may be capable of either full color, monochrome/grayscale or still image capture, with the device controller 314 operating to select the video function of the videocamera subject to user preferences. In other examples, the videocamera is only equipped to provide one type of video (such as monochrome/grayscale) and the controller simply accepts the video that is provided. Note also that videocamera 306 may be provided with an audio microphone (mic) 336 for capturing audio along with the video. Depending upon the particular videocamera, the controller may control the type of audio to be obtained such as, for example, by selecting the sampling rate for the audio (e.g. 22 kilohertz vs. 44 kilohertz).

Device controller 314 includes, in this example, a video input component 338 for receiving video from the videocamera, a video compression controller 340 for selectively compressing the video and a video storage device 342 for storing the selectively compressed video. Input of video from the videocamera may employ any suitable video connection such as composite video, S-Video, Digital Visual Interface (DVI) or High-Definition Multimedia Interface (HDMI) with the video input of the device controller matched to the video output of the videocamera. The video storage component may be any suitable storage device such as flash memory or random access memory RAM. If video compression is employed, it may be adapted to selectively compress the video to retain features of interest at higher resolution while more aggressively compressing features of lesser interest. In this regard, vehicles, license plate numbers and the faces of individuals are typically of particular interest in accident and criminal investigations and hence these features of the video image may be identified in the image by the video compression controller so that those portions of the image can be fully retained without compression. Indeed, the video compression controller may be programmed to selectively sharpen these portions of the image. On the other hand, various other features of the video captured by the videocamera as the vehicle drives along a road or street, such as trees, clouds, shrubbery, buildings, etc., may not be of much interest to accident or criminal investigators and hence can be aggressively compressed. In this manner, input video images—particularly full color HD images—can be selectively and aggressively compressed while retaining and sharpening features of interest so as to reduce the bandwidth needed to transmit and store the images. Since monochrome/grayscale images or still images require less bandwidth than full color HD video, compression of monochrome/grayscale images and/or still images may be less aggressive or may not employed at all, depending upon the programming of the device controller and the preferences of the user.

Device controller 314 also includes, in this example, an audio input component 344 for receiving audio from the videocamera, an audio compression controller 346 for selectively compressing the audio and an audio storage device 348 for storing the selectively compressed audio. Input of audio from the videocamera may employ any suitable audio connection such as RCA or XLR connectors with the audio input of the device controller matched to the audio output of the videocamera. Depending upon the video output of the videocamera, audio may be included so that a separate audio input is not needed. As with video, the audio storage component may be any suitable storage device such as flash memory or RAM and, in many examples, audio and video will be stored in the same memory device. If audio compression is employed, it may be adapted to selectively compress the audio to retain features of interest at higher resolution while more aggressively compressing features of lesser interest. In this regard, voices, car horns, skidding sounds and the like are typically of greater interest in accident investigations and criminal investigations than ambient sounds (car noise, wind noise, etc.) and hence these features of the audio signal may be identified by the audio compression controller for selective compression. In this manner, input audio—particularly high sampling rate audio—can be selectively and aggressively compressed while retaining audio features of interest so as to reduce the bandwidth needed to transmit and store the audio. Given that audio generally consumes far less bandwidth than video, audio compression may be less useful than video compression but is illustrated in FIG. 3 for the sake of completeness.

Device controller 314 also includes, in this example, a GPS system 350 for detecting, determining or otherwise tracking the location of the vehicle in terms of latitude or longitude or other suitable parameters so that this information may be output along with audio/video. The GPS system may be an otherwise conventional GPS system such as the type commonly employed in smartphones or the like. A system clock 352 tracks the date and time so that this information may also be output along with audio/video as a combined audio/video-lat./long.-date/time data record. In this manner, the audio/video data record is “time stamped” and “location stamped” to permit authorized personnel such as accident investigators to find audio/video records once uploaded to cloud-based storage/access system 324, as already discussed.

To facilitate outputting or uploading of the data, the device controller may include one or more of a wireless transmission system 354, a memory card and/or flash card port 356, a USB output system 358, a BlueTooth™ system 359 or a Wi-Fi output system 360. Wireless transmission system 354 may be the same or similar to the wireless transmission systems of smartphones or other mobile phones and may be equipped to transmit data in accordance with any suitable protocol such as 3G or 4G. Wi-Fi output 360 system may be the same or similar to conventional wireless adapters for connecting to a wireless hub or hotspot. A tethering system 361 may be used to tether device controller 314 to another device positioned in, on or near the vehicle to facilitate wireless networking. An on-board computer interface 363 may be provided to interface with an on-board vehicle computer (if the vehicle is so equipped) to download data from the on-board computer such as video obtained by the on-board computer from other videocameras in the vehicle, as well as information pertaining to vehicle speed, mechanical issues, etc. In particular, and as will be discussed in greater detail below, if the on-board computer is equipped to detect an imminent impact and/or an impact that has just occurred, indicators can be downloaded into device controller 314 for relaying to the cloud-based storage/access system. Likewise, if the on-board computer is equipped to detect an authorized break-in to the vehicle via an alarm system, indicators can be downloaded into the device controller and relayed to the cloud-based storage/access system. In some examples, BlueTooth™ or similar technologies are employed to facilitate access to the on-board computer or to other devices within the vehicle.

Depending upon the programming of device controller 314 and the particular circumstances, the audio/video data (compressed or otherwise) along with the corresponding date/time and location may be continuously streamed (i.e. transmitted substantially in real-time) to the cloud-based storage/access system 324 by wireless transmission system 354 via an external wireless system (such as wireless network 120 of FIG. 1). This helps ensure that audio/video is properly retained by the cloud storage system even in the event of an accident that might destroy the device controller and other in-vehicle components. However, to reduce mobile access fees, the device controller may be programmed to transmit the audio/video data intermittently, periodically or on-demand. Still further, there may be circumstances where audio/video data cannot be streamed to a wireless network, such as if no wireless signal is currently available. Hence, the device controller may be programed to wait until a wireless signal or a Wi-Fi signal is available, and then upload the data using 3G, 4G or Wi-Fi as appropriate. In some examples, audio/video data is retained in the device controller until the vehicles returns to the home of the driver, at which time the system uploads all audio/video recorded that day using a home Wi-Fi network. If such is not available, the audio/video may be output to a suitable memory card (such as a memory stick or PCMCIA card) using memory card output system 356. These and other functions of the device controller operate under the control of an upload controller 362, which may be a programmable computing component. The uploads may be encrypted using any suitable encryption technique by an encryption/decryption controller 365.

Power for operating device controller 314 and videocamera 306 is received through a power input component 364 and output, as needed, to the videocamera via a power output component 366. Any power conversion that may be required (such as from a 12-volt power socket input to the particular voltages needed by the device controller and videocamera) is performed by a power converter 368. The device controller may also have a touch screen display such as a 5-inch LCD display, which operates under the control of a display controller 369 to display control information and to accept user input via its touch screen, such as commands to activate or deactivate the videocamera. The display may also display video captured by the videocamera to, for example, allow the operator to verify that the videocamera is working and it is positioned properly. A central processor 363 controls the operation of the various components of the device controller. Any of a wide variety of technologies may be used to implement the central processor and the various other components of device controller 314. In some examples, the central processor may be configured using Raspberry Pi or similar technology.

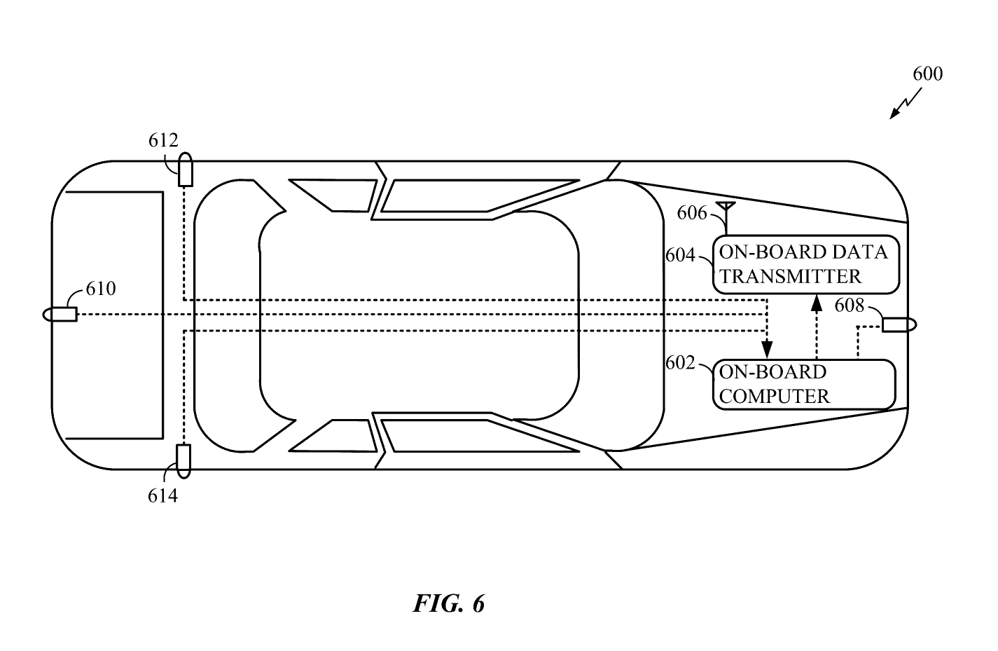

Cloud-based storage/access system 324 includes, in this example, an audio/video record input system 370 for receiving data records providing audio/video, lat./long. and date/time from various vehicles or vehicle-mounted apparatus, which are stored within a data record storage system 372 for selective access via a data retrieval system 374. If the incoming data is encrypted, an encryption/decryption controller 377 operates to decrypt the data. In some examples, all of the data maintained within the cloud storage system is kept encrypted until it is accessed by an authorized user, and then it is selectively decrypted, as needed. Queries received from authorized users are input via a query input unit 376. Payment of the aforementioned fee to the owner of the particular video capture apparatus that provided the audio/video found in the search (or the owner/lessee of the vehicle in which it is installed) may be controlled by a payment authorization system 378. Note that the cloud-based storage/access system preferably treats the vehicle-based system or apparatus that provides data as a “black box,” i.e. the cloud-based system simply receives and stores audio/video and other data in a certain format so that the configuration details of the device or apparatus that provides the data are not relevant. In this manner, the cloud-based storage/access system can receive and process data from a variety of devices such as apparatus 102 of FIG. 1 or integrated on-board vehicle computing systems of the type shown in FIG. 6 and described in greater detail below.

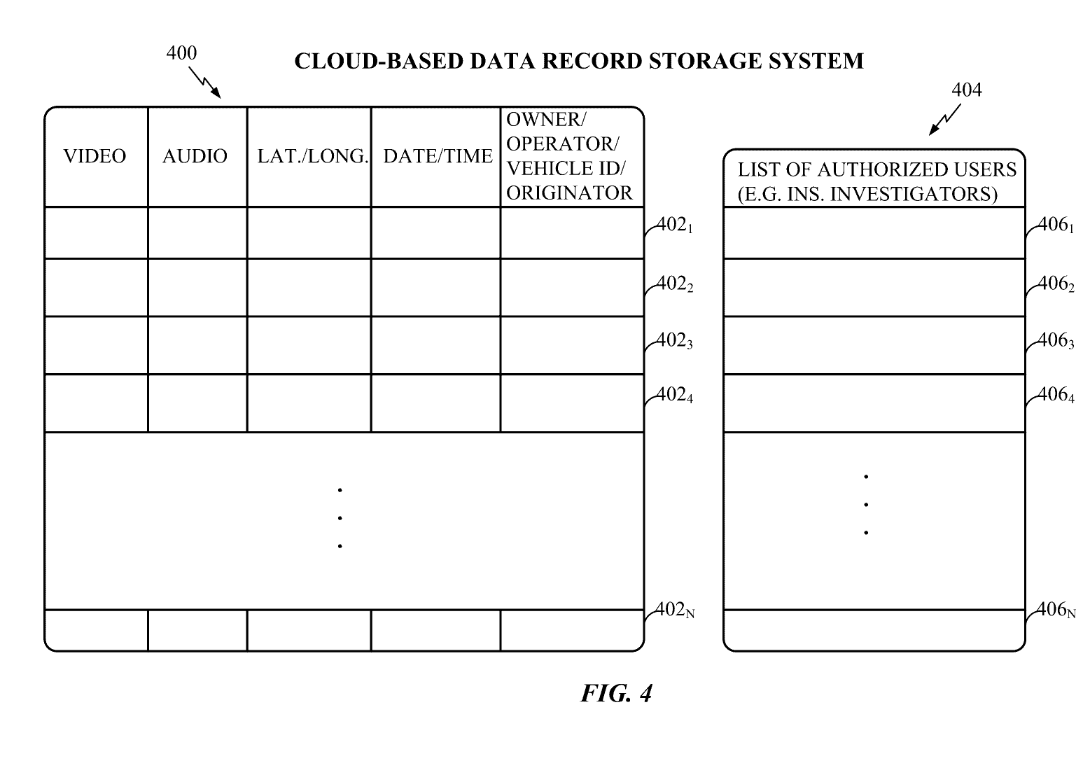

FIG. 4 illustrates an exemplary cloud-based data record storage system, which may be used with the cloud-based system 324 of FIG. 3. In this example, the data record storage system includes a data record database 400 that stores a set of records 402₁-402_{N}, each of which may include video data, audio data, lat./long. data, date/time data and data identifying the owner or operator associated with the data record and/or a vehicle ID, i.e. data identifying the “originator” of the data. When data is collected from a video capture apparatus such as the one shown in FIG. 1, the “operator” is typically the registered owner of the apparatus. If data is instead obtained directly from an on-board computer of the vehicle itself, then the owner is typically the registered owner or lessee of the vehicle. In an exemplary implementation, each data record may store, e.g., thirty seconds of video/audio data along with the lat./long. of the vehicle at the start of that interval and the date/time at which the data record begins. That is, each thirty second interval or data is time-stamped and location-stamped to identify that interval of video data for ease of searching. The next thirty second interval of data obtained from the same vehicle will be time stamped and location stamped with updated date/time data and lat./long. data. In other examples, a greater or lesser amount of audio/video data is stored in each individual record, such as only ten seconds or sixty seconds or perhaps several minutes. It should be appreciated, however, that a vehicle can cover considerable distance over a period of several minutes and so searches may be more precise if each data record covers a only a relatively short interval of time. The cloud-based data record storage system of FIG. 4 also records a list of authorized users in a user database 404, which includes a set of records 406₁-406_{N} that identify insurance investigators, law enforcement investigators or other personnel or agencies authorized to access database 400.

Note that database 400 will typically store data records for all registered owner/operators in the overall system and hence may contain data for thousands or perhaps millions of drivers. This may be quite a lot of data. In a typical implementation, once the database becomes full, the oldest data is erased to make room for newly acquired data, i.e. first-in, first-out. The amount of data to be retained at any given time depends, of course, on the storage capacity of the overall system. To facilitate storage of large amounts of data, various server farms may be provided around the country (or around the world) with data automatically routed to the nearest server farm. Still further, note that some data records may be designated for non-erasure. For example, if an automobile accident is known to have occurred at a certain location and time, then all audio/video data collected in the vicinity of that location and around that particular time may be retained indefinitely so that it can be accessed by authorized personnel long after the accident, if needed.

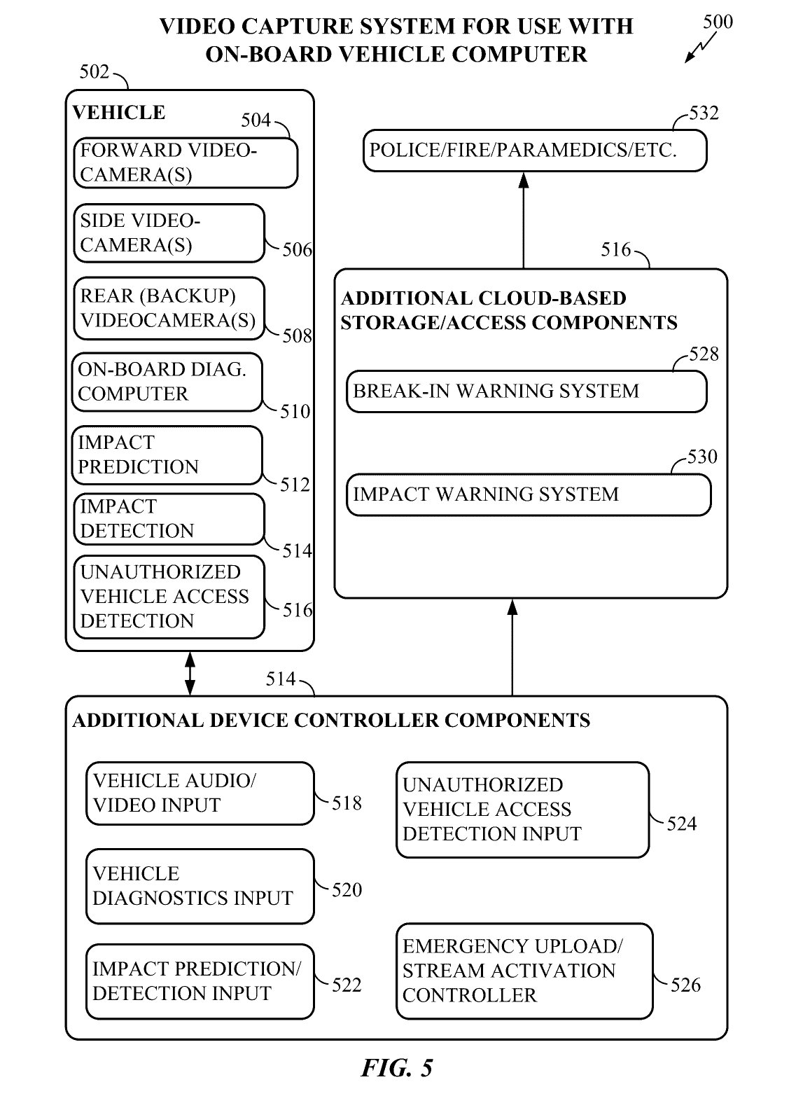

FIG. 5 illustrates a system 500 where the video capture apparatus (such as apparatus 102 of FIG. 1) operates in conjunction with an on-board computer of the vehicle. In this example, vehicle 502 includes one or more forward-facing videocameras 504, one or more rear-facing videocameras 506, one or more side-facing videocameras 508 and an on-board diagnostics computer 510, which may detect and track the on-going operations of the vehicle. The vehicle also includes an impact prediction component 512 for predicting an imminent impact based, e.g., on the momentum of the vehicle and the proximity of objects ahead of the vehicle (such as another car). An impact detection component 514 detects any significant impact using one or more sensors. An unauthorized vehicle access detection component 516 detects an attempted break-in to the vehicle or other unauthorized access using, for example, car alarms or the like. Any or all of this information may be relayed to device controller 514 of the video capture apparatus then streamed or otherwise uploaded to cloud-based storage/access system 516.

In the example of FIG. 5, device controller 514 includes (in addition to the components shown in FIG. 3): a vehicle audio/video input component 518 for receiving audio and/or video from the vehicle; a vehicle diagnostics component 520 for receiving diagnostic data from the vehicle; an impact prediction/detection input component 522 for receiving impact predictions and/or detections from the vehicle; and an unauthorized vehicle access detection input component 524 for receiving alarms or warnings from the vehicle of a break-in or the like. An emergency upload/stream activation controller 526 is operative to respond to data provided by the vehicle to, for example, quickly relay impact predictions/detections to cloud-based system 516. Additionally, in the case of an unauthorized access, upload controller 526 may activate one or more videocameras (which might not have been turned on) to capture images of the perpetrators for streaming or uploading to the cloud-based system. These and other features will be described in greater detail below. In the example of FIG. 5, cloud-based system also includes (in addition to components shown in FIG. 3): a break-in warning system 528 and an impact warning system 530. These components respond to warnings received from the device controller by, for example, notifying police, fire, paramedics or other authorities 532 of an accident detected based on vehicle impact (via a message to 911, for example) and/or notifying the owner of the vehicle (via a text message or the like to their smartphone) of an unauthorized access attempt to the vehicle (thus allowing the owner to investigate and call the police if needed). Audio/video or other data collected by the cloud-based system during or before an accident or a break-in of the vehicle may be flagged so that it will not be automatically deleted (as other data might be in due course, subject to database size limitations, etc.)

FIG. 6 illustrates an implementation where the vehicle includes on-board components for collecting video (and, in some examples, corresponding audio) and for uploading that data to an external communications network for relaying to the cloud-based storage/access system of FIG. 3. Hence, FIG. 6 shows a vehicle in which a separate video capture apparatus (such as apparatus 102 of FIG. 1) is not needed. However, even within a vehicle equipped as in FIG. 6, it is feasible to also use a separate video capture apparatus to provide additional video data, if desired. The illustration of FIG. 6 is a stylized top-view representation of a sedan 600 having an on-board computer 602 and an on-board data transmitter 604 connected to an antenna 606 (shown schematically). A set of videocameras is also shown including: a forward-facing videocamera 608, a rear-facing videocamera 610, a first side-facing videocamera 612 and second, opposing side-facing videocamera 614. Control/data lines are shown (in phantom lines) interconnecting the various components. With this configuration, video obtained by the on-board computer is selectively relayed to the on-board transmitter and streamed or otherwise uploaded to a communications network for relaying to the to the cloud-based storage/access system of FIG. 3. Although not specifically shown in FIG. 6, the on-board computer may include any or all of the components of the device controller of FIG. 3, such as components for compressing video, obtaining the lat. and long. of the vehicle, etc. Still further, the on-board computer may include components for tracking the diagnostics of the vehicle, such as detecting tire blowouts or the like. Any or all of the data may be uploaded along with the video (and audio) obtained from the various videocameras. Moreover, as will be further described below, the on-board computer may have components for detecting an impact, detecting an unauthorized access to the vehicle (i.e. a break-in). This data may be used to trigger various operations. Note that the vehicle of FIG. 6 may be operator driven or self-driving, if so equipped.

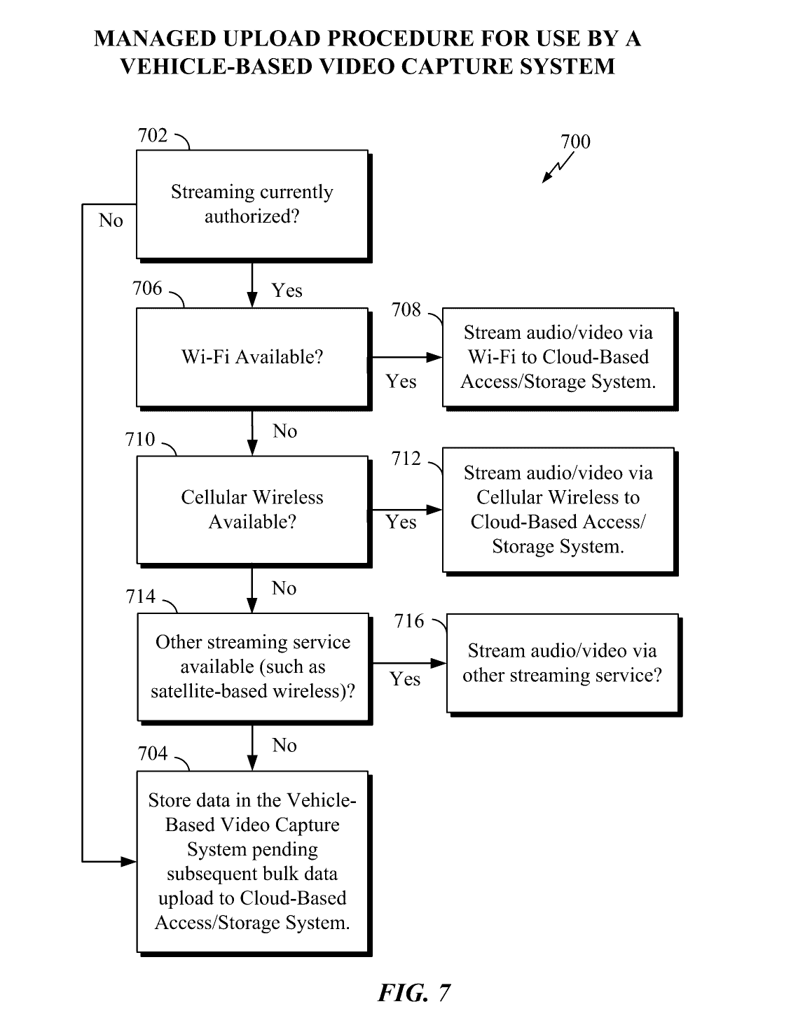

FIG. 7 illustrates an exemplary procedure 700 for managing or otherwise controlling the uploading of audio/video data and other data from a vehicle to the cloud-based data record storage system to help make it cost effective. In some examples, any or all of the transmissions may be encrypted. The method of FIG. 7 may be performed, for example, by the video capture apparatus 102 of FIG. 1 or by the on-board integrated vehicle computing system of FIG. 6. Either of these systems may be generally referred to herein as a “vehicle-based video capture system.” At 702, the vehicle-based video capture system determines whether streaming is currently authorized by the user/owner of the vehicle-based video capture system and, if not, audio/video and other data obtained by the system is stored in the memory of the vehicle-based video capture system pending a subsequent bulk data upload to the cloud-based access/storage system. In this regard, given that continuous streaming of audio/video data from the vehicle to the cloud-based system via a wireless connection may be expensive, some users may not authorize streaming and may instead prefer a periodic or on-demand bulk upload.

Assuming that streaming is authorized, the vehicle-based video capture system determines at 706 whether Wi-Fi is available and, if so, streams audio/video via Wi-Fi at 708 to the cloud-based access/storage system. That is, the vehicle-based video capture system determines whether it is in the vicinity of one or more Wi-Fi devices (hotspots, etc.) through which the data can be streamed. For example, if the vehicle is parked at home, the vehicle-based video capture system may be able to use a home Wi-Fi system. If Wi-Fi is not available, the vehicle-based video capture system determines at 710 whether cellular wireless (e.g. 3G/4G) is available and, if so, the vehicle-based video capture system streams audio/video via cellular wireless to the cloud-based access/storage system. It is noted that Wi-Fi is assessed first (at 706) before cellular is assessed (at 710) since Wi-Fi is generally less expensive than cellular wireless and hence may be the preferred form of transmission. If cellular is not available, the vehicle-based video capture system determines at 714 whether some other form of streaming service is available (such a satellite-based wireless) and, if so, the vehicle-based video capture system streams audio/video using that other streaming service to the cloud-based access/storage system. If no streaming services are found to be authorized and available, the vehicle-based video capture system stores data for a subsequent bulk upload at 704, as already discussed.

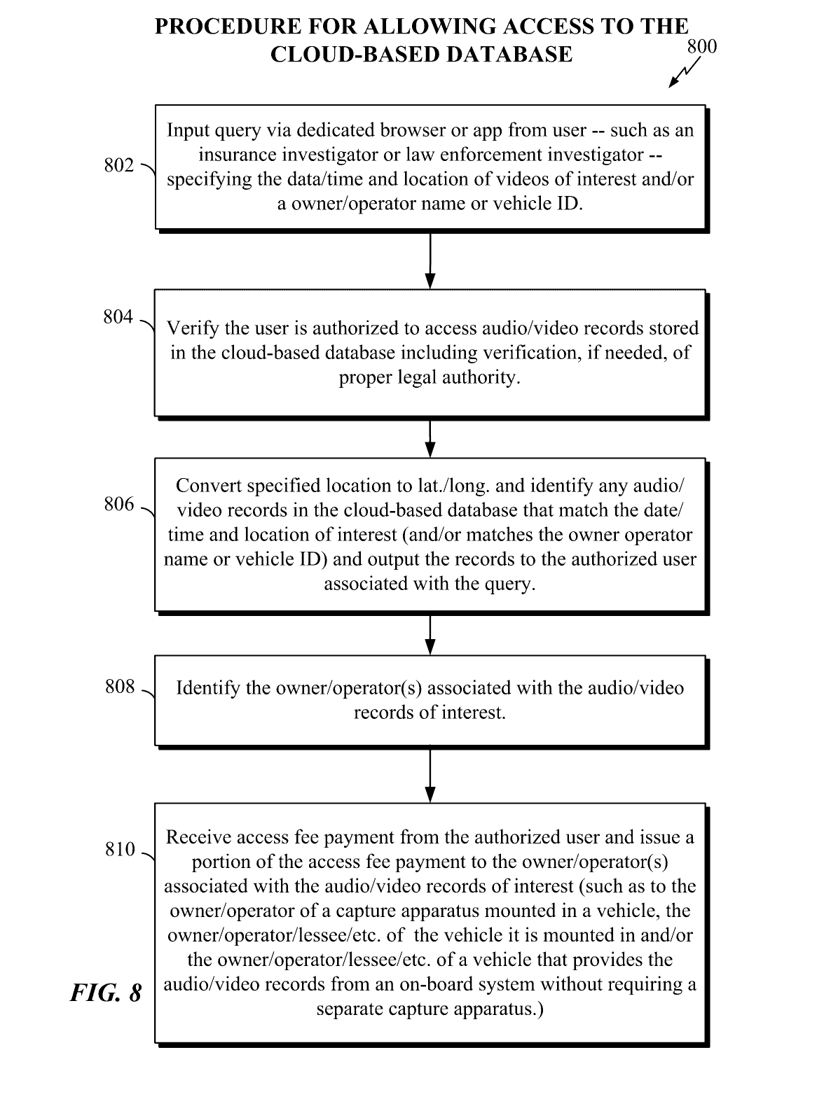

FIG. 8 illustrates an exemplary procedure 800 for allowing access to the cloud-based data record storage system. This method may be performed, for example, by control components of the database such as components access system 124 of FIG. 1 or by API components 121 of FIG. 1 that interface with the storage/access system. At 800, the system inputs a query via a dedicated browser or suitable app from a user—such as an insurance investigator or law enforcement investigator—specifying the data/time and location of videos of interest. The location may be specified, for example, in terms of a street address or a set of lat./long. coordinates. A query may additionally or alternatively specify the owner/operator of the device that uploaded the audio/video data and/or a vehicle ID. At 804, the system verifies that the user is authorized to access audio/video records stored in the cloud-based database including verification, if necessary, of proper legal authority. In this regard, law enforcement or court officials may be authorized to access the database pursuant to a subpoena or the like even if they are not otherwise a subscriber to the data in the system (as with insurance companies).

At 806, the system converts the specified location (assuming a location has been entered) into lat./long. values (if needed) and identifies any audio/video records in the cloud-based database that match the date/time and location of interest (and/or matches an input operator name or vehicle ID) and outputs the records to the authorized user associated with the query. As already explained, the data may be reviewed to determine who is at fault in an accident or to assist in identifying or tracking the perpetrators of crimes or for other authorized purposes. Note that other more sophisticated searches may be performed as well, depending upon the programming of the system, such as image recognition-based searches to identify videos that captured images of particular vehicles (as detected, e.g., by the license plate number) or captured images of particular individuals (based on facial recognition or other metrics). At 808, the system identifies the owner/operator(s) associated with the audio/video records of interest and, at 810, the system receives an access fee payment from the authorized user (assuming one is to be paid) and issues a portion of the access fee payment to the owner/operator(s) associated with the audio/video records of interest (such as to the owner/operator of a capture apparatus mounted in a vehicle, the owner/operator/lessee/etc. of the vehicle it is mounted in, and/or the owner/operator/lessee/etc. of a vehicle that provides the audio/video records from an on-board system without requiring a separate apparatus). In this manner, a portion of fees paid by insurance investigators and/or criminal investigators to access the system and obtain video(s) are, in turn, paid to the originator of the video(s) of interest to help encourage participation in the system.

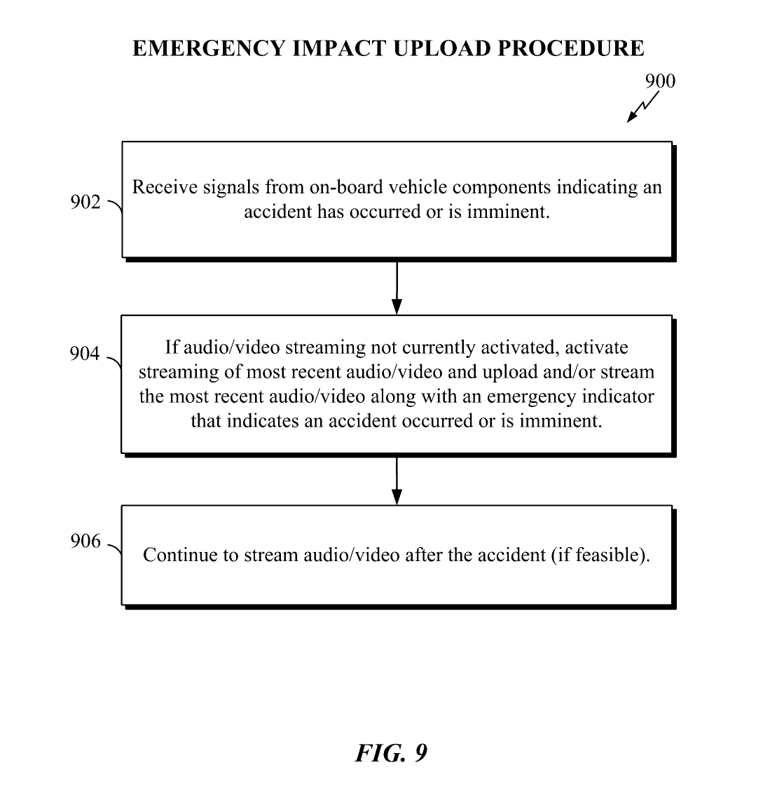

FIG. 9 illustrates an exemplary procedure 900 for initiating an upload of video data in the event of a vehicle impact (in circumstances where video is not already streaming). The method may be performed, for example, by the video capture apparatus 102 of FIG. 1 based on warnings received from an on-board vehicle computer or by the on-board integrated vehicle computing system itself if so equipped (as shown in FIG. 6). That is, the method may be performed by a vehicle-based video capture system as that term is used herein. At 902, the vehicle-based video capture system receives signals from on-board vehicle components indicating an accident has occurred or is imminent. At 904, if audio/video streaming not currently active, the vehicle-based video capture system activates streaming of most recent audio/video and uploads and/or streams the most recent audio/video along with an emergency impact indicator. At 906, the vehicle-based video capture system continues to stream audio/video after the accident (if feasible). That is, the vehicle-based video capture system will continue to stream data after an accident unless it is too damaged to do so by the impact to transmit data.

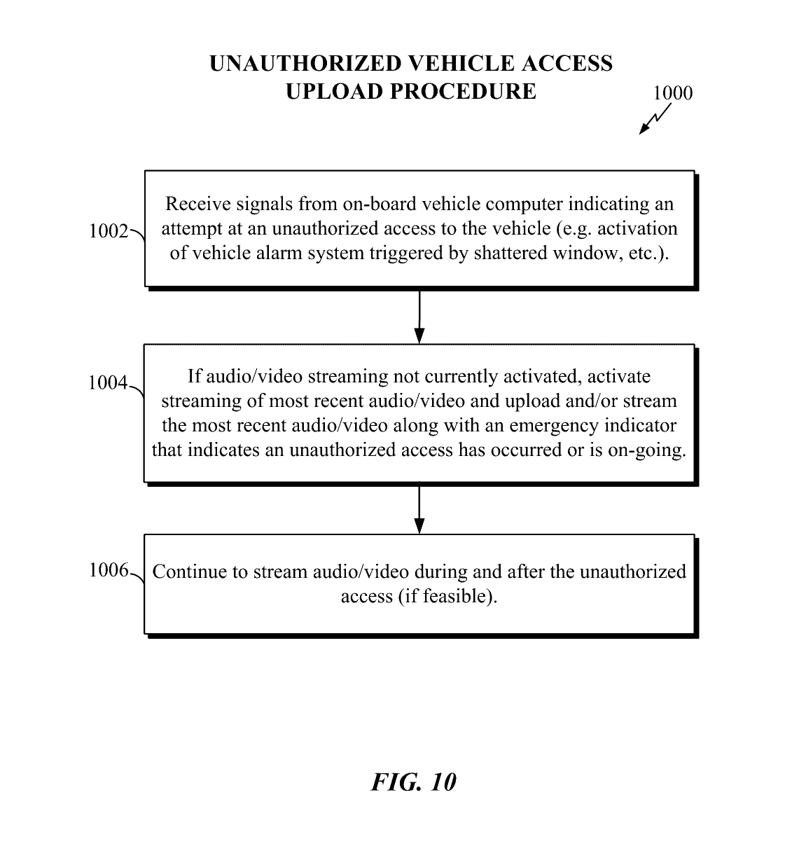

FIG. 10 illustrates an exemplary procedure 1000 for initiating an upload of video data in the event of an unauthorized access attempt such as a break-in (in circumstances where video is not already streaming). This method may be performed, e.g., by the video capture apparatus 102 of FIG. 1 based on warnings received from an on-board vehicle computer or by the on-board integrated vehicle computing system itself if so equipped. That is, this method may also be performed by a vehicle-based video capture system as that term is generally used herein. At 1002, the vehicle-based video capture system receives signals from on-board vehicle components (such as its car alarm) indicating an attempt at an unauthorized access to the vehicle (e.g. activation of the vehicle alarm system as triggered by shattered window, etc.). At 1004, if audio/video streaming not currently active, the vehicle-based video capture system activates streaming of the most recent audio/video and uploads and/or streams the most recent audio/video along with an emergency indicator that indicates that an unauthorized access has occurred or is on-going. At 1006, the vehicle-based video capture system continues to stream audio/video during and after the unauthorized vehicle access (if feasible). By activating video streaming upon detection of an attempt at an unauthorized access to the vehicle (such as break-in), video may thereby be obtained that might reveal the identity of the perpetrators.

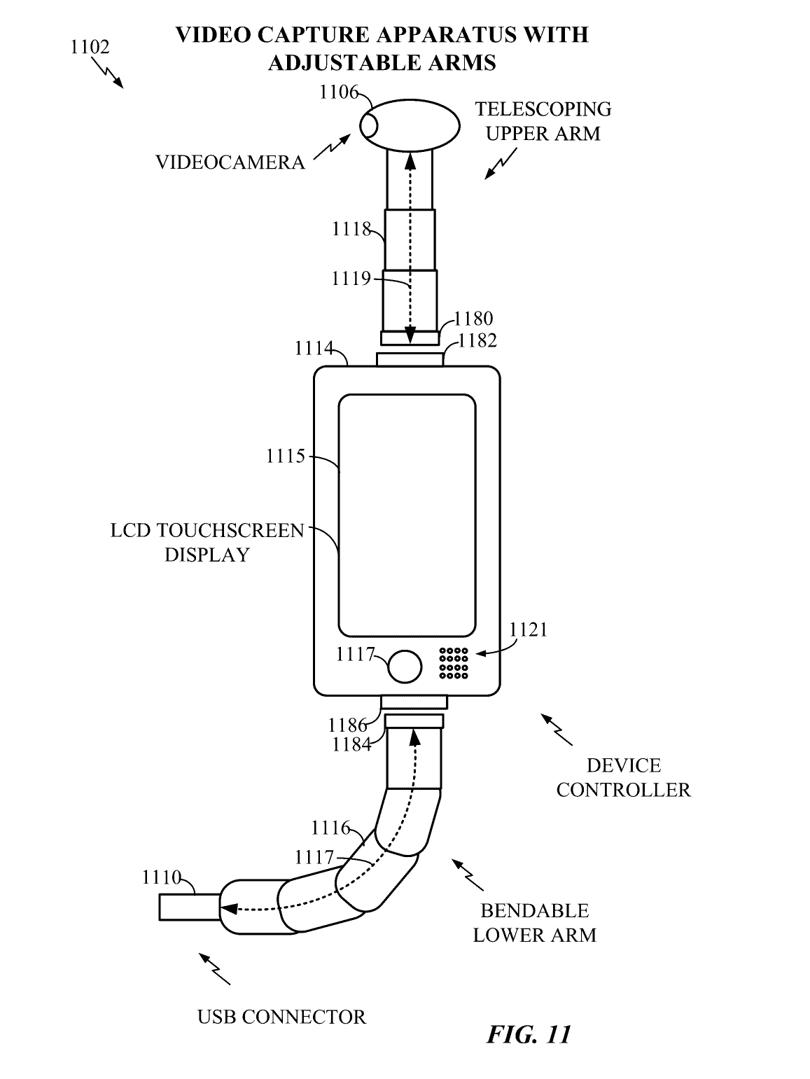

Turning now to FIGS. 11-13, various exemplary designs for the upper and lower arms of a video capture apparatus are illustrated. In FIG. 11, apparatus 1102 includes a videocamera 1106, a device controller 1114, a lower mounting arm 1116 and an upper mounting arm, as well as a USB connector 1110 for connecting into a USB port in, e.g., the dashboard of a vehicle. The device controller includes an LCD display 1115 for displaying, for example, videos captured by the videocamera or commands or other control information. Audio may be played using a speaker 1121. The audio may include audio recorded by the videocamera or, for example, various audio commands or prompts, etc. An on/off power button 1117 is also provided. As can be seen, the upper arm is a telescoping arm to permit its length to be adjusted and/or selected. The lower arm is a bendable arm to allow it to be bent to permit ease of mounting. In this example, both the upper and lower arms are detachably connected to the device controller by suitable connectors such as additional USB connectors. More specifically, a proximal end of upper arm 1118 includes a connector 1180 to be fitted into a corresponding connector 1182 on the top end of the device controller. One or more wires, cables or other connection lines (shown by way of phantom line 1119) are provided within the upper arm for relaying control signals and/or data between the videocamera and the device controller. Likewise, a proximal end of lower arm 1116 includes a connector 1184 to be fitted into a corresponding connector 1186 on the bottom end of the device controller. One or more wires, cables or other connection lines (shown by way of phantom line 1117) are provided within the lower arm for relaying power, control signals and/or data between the power connector and the device controller. The use of releasable connectors on the upper and lower arms allows both arms to be conveniently detached and, if needed, replaced with different arms that might be better suited for the vehicle in which the apparatus is to be mounted. In other examples, either or both of the arms may be permanently affixed to the controller.

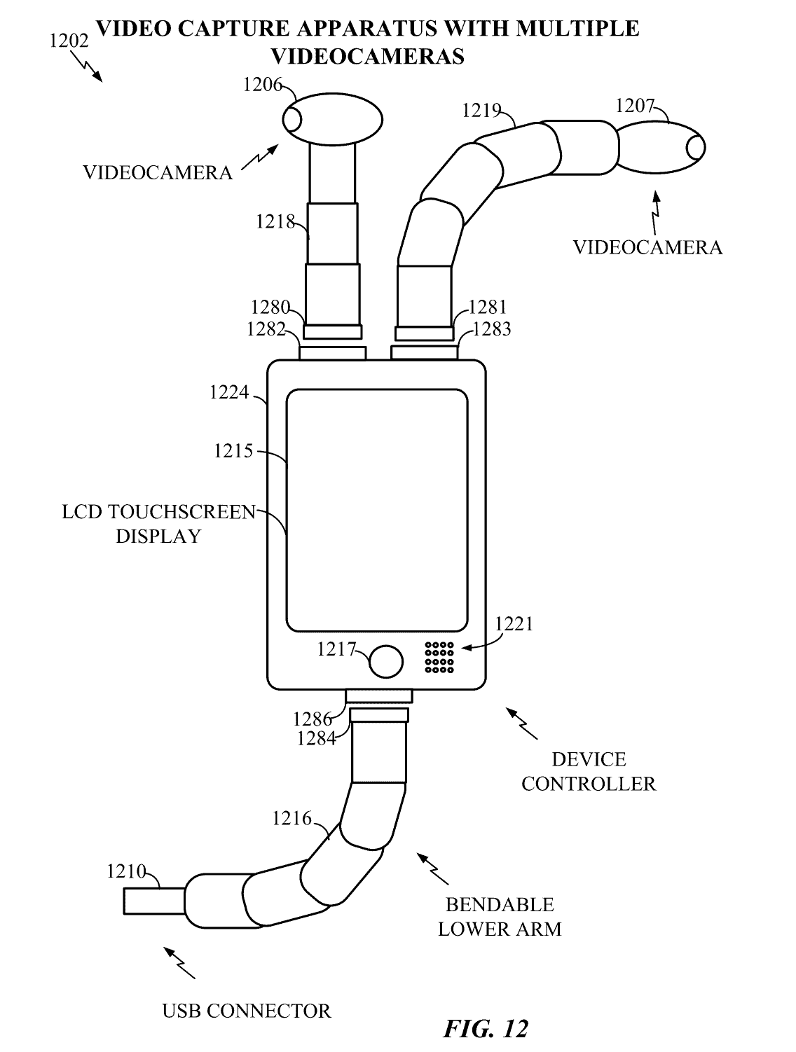

In FIG. 12, apparatus 1202 includes a device controller 1204, a lower mounting arm 1216 and USB connector 1210. The device controller includes an LCD display 1215, speaker 1221 and an on/off power button 1217. Two upper arms are provided 1281, 1219 to accommodate two videocameras 1206, 1207, which may be independently oriented. Videocamera 1206 is detachably connected to the device controller via arm 1218 using connectors 1280 and 1282. Videocamera 1207 is detachably connected to the device controller via arm 1219 using connectors 1281 and 1283. Upper arm 1218 is a telescoping arm whereas upper arm 1219 is a bendable arm. The lower arm is also bendable in this example. Although not specifically shown in FIG. 12, the upper and lower arms will include cables and/or wires for relaying data, control signals and power.

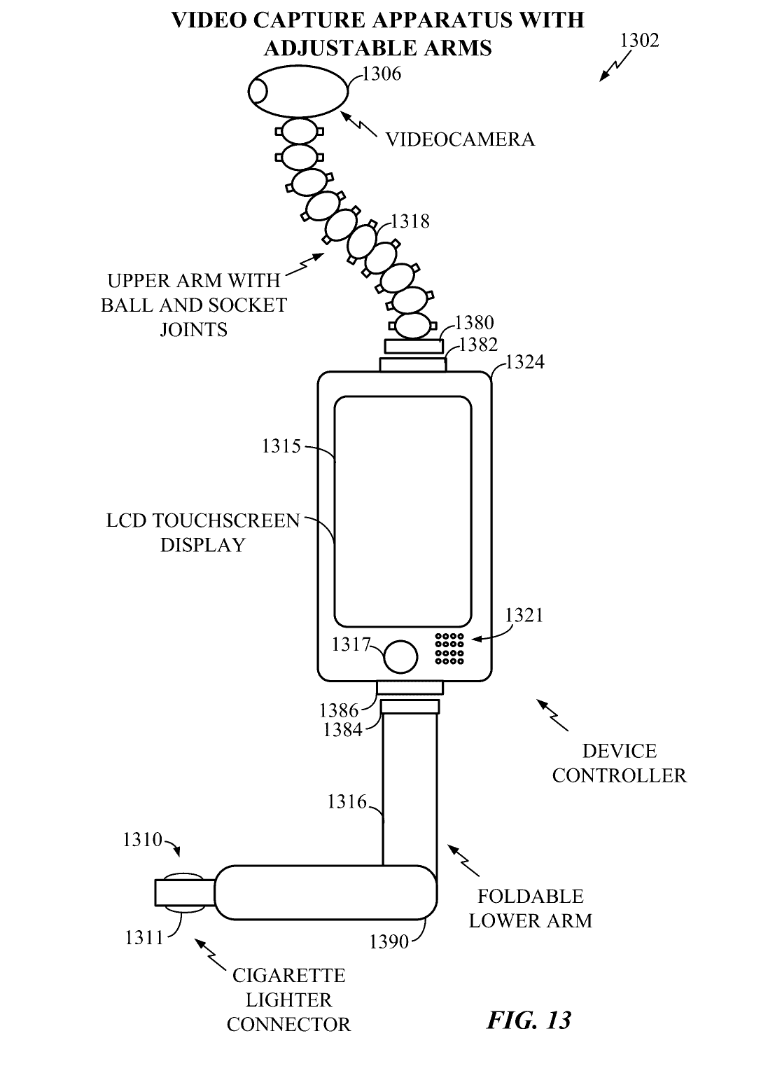

In FIG. 13, apparatus 1302 includes a device controller 1304, a lower mounting arm 1316, an upper mounting arm 1318 and, in this example, a cigarette lighter connector (i.e. a socket charger power plug) 1310, which includes flexible power contacts 1311. The device controller includes an LCD display 1315, speaker 1321 and an on/off power button 1317. Upper arm 1318 is an articulated arm formed of ball-and-socket joints, allowing it to be easily bent or twisted in a variety of desired orientations. Lower arm 1316 is a foldable arm that folds along an elbow joint 1390. In this example, the lower arm is detachably connected to the device controller via connectors 1386 and 1384. Upper arm 1318 is likewise detachably connected via connectors 1380 and 1382. Although not specifically shown in FIG. 13, the upper and lower arms will include cables and/or wires for relaying data, control signals and power. FIGS. 11-13 provide just a few examples of possible arm arrangements, which are merely illustrative and not limiting. As can be appreciated, in some examples, both the upper and lower arms might include foldable elbow joints or both the upper and lower arms might include ball-and-socket joints. Other adjustable arm mechanisms not specifically shown herein may be used as well.

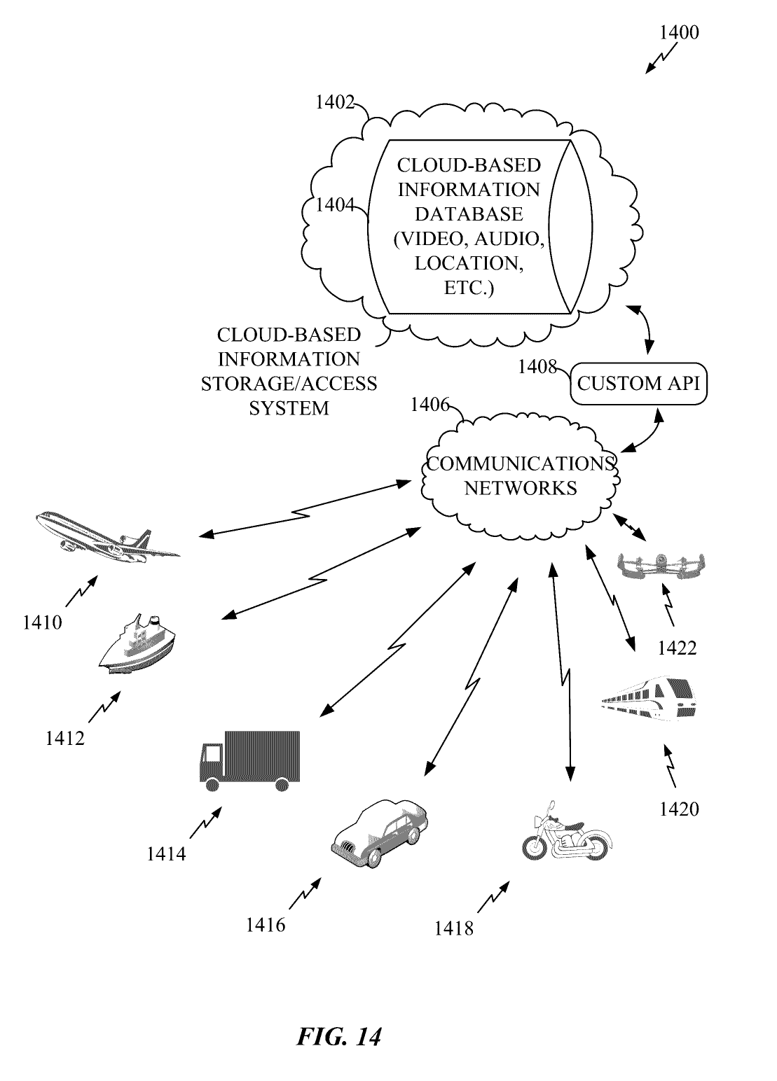

FIG. 14 broadly illustrates that video and other data may be collected from a variety of types of vehicles or transports, obtained from an apparatus such as 102 of FIG. 1 or from an on-board integrated computing system as in FIG. 6 or from other suitable devices, components or apparatus. Briefly, FIG. 14 illustrates an overall system 1400 that includes a cloud-based information storage/access system 1402, which includes a cloud-based information database 1404 for storing video, audio, location, etc., as already described. Information for storage in the database is received from various vehicles via one or more communication networks 1406 using a custom API 1408. Exemplary vehicles shown in FIG. 14 include an airplane, jet or other aircraft 1410, a boat, ship or other watercraft 1412, a truck or other delivery vehicle 1414, a car or automobile 1416 (which may be a self-driving automobile), a motorcycle, moped or motor-scooter 1418, a train 1420 such as a freight train, commuter train, locomotive, etc., and a drone 1422. These are just some examples of vehicles that may be equipped to provide video or other information for storage in the cloud-based system. Still further, although cloud-based systems are described herein an example of a means for storing and access the data, other such means may be employed, such as non-cloud-based servers or computing systems.

### Summary of Vehicle-Based Cloud-Aware Video Capture Systems and Components

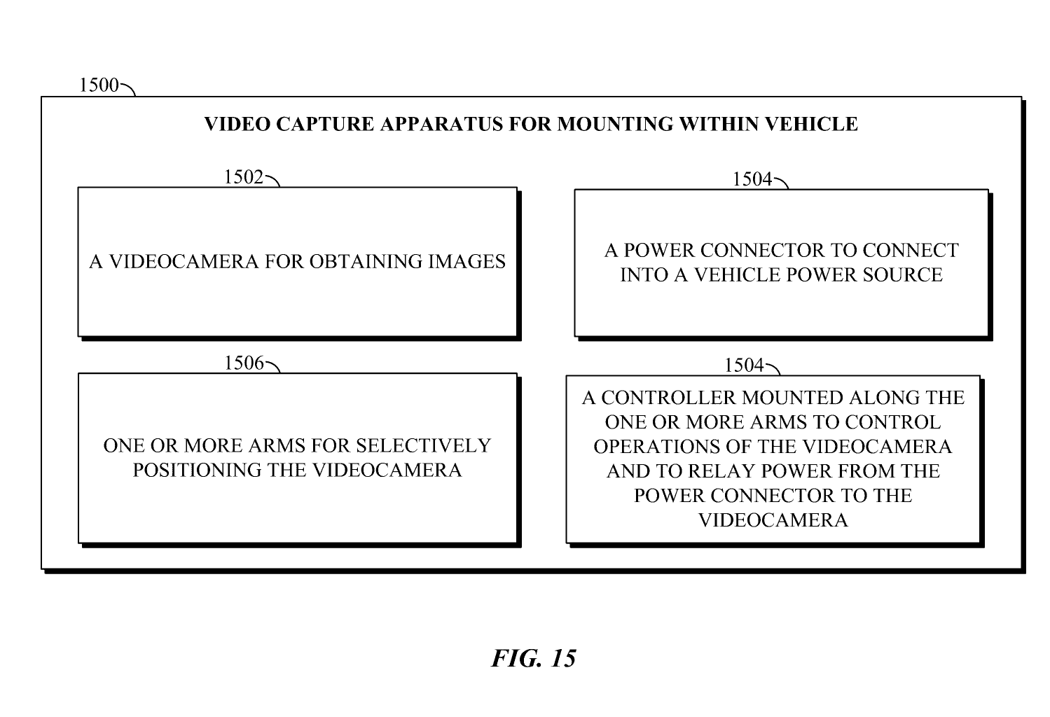

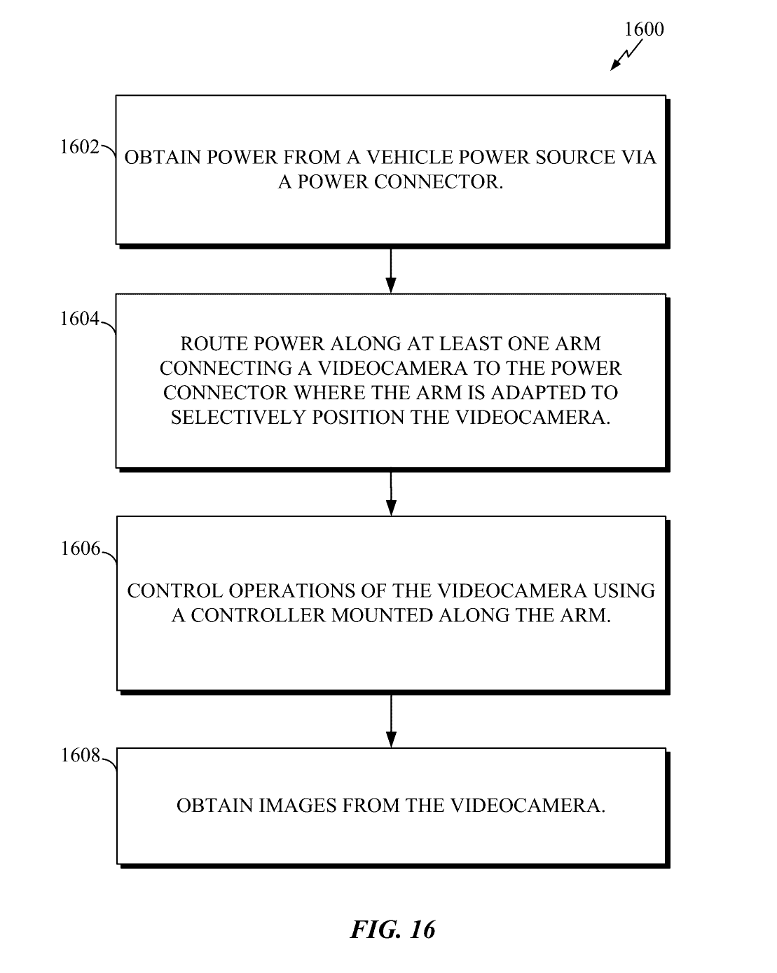

FIG. 15 summarizes selected components of a video capture device, system or apparatus 1500 for mounting on or within a vehicle or other transport. A videocamera or other image capture device 1502 is provided for obtaining images. One or more arms or other mechanisms 1506 are provided for selectively positioning the videocamera. A power connector 1504 is provided for connection into a vehicle power source. A controller 1504 is provided for mounting along the one or more arms 1506 to control operations of videocamera 1502 and to relay power from power connector 1504 to the videocamera. FIG. 16 summarizes selected steps of a procedure 1600 for use by the apparatus of FIG. 15 or other suitably equipped devices, systems or apparatus. At 1602, power is obtained from a vehicle power source via a power connector. At 1604, the power is routed along at least one arm connecting a videocamera to the power connector where the arm is adapted to selectively position the videocamera. At 1606, operations of the videocamera are controlled using a controller mounted along the arm and, at 1608, images are obtained from the videocamera.

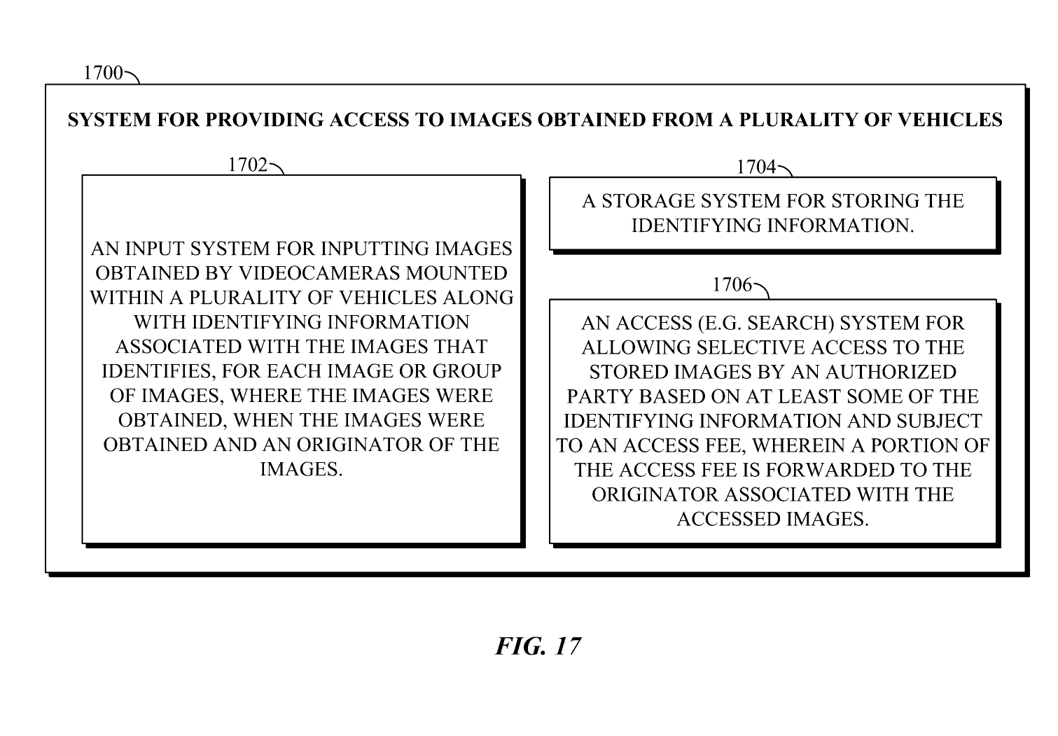

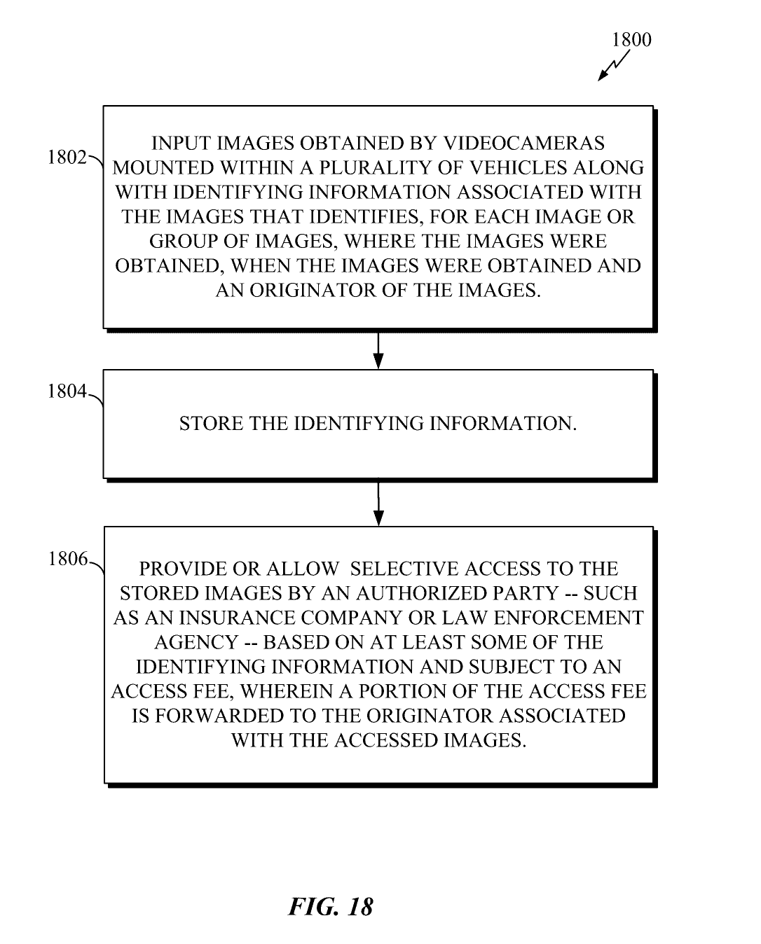

FIG. 17 summarizes selected components of a system, device or apparatus 1700 for providing access to images obtained from a plurality of vehicles. An input system 1702 is provided for inputting images obtained by videocameras mounted within a plurality of vehicles along with identifying information associated with the images that identifies, for each image or group of images, where the images were obtained, when the images were obtained and an originator of the images. A storage system 1704 is provided for storing the identifying information. An access system 1706 is provided for allowing selective access to the stored images by an authorized party based on at least some of the identifying information and subject to an access fee, wherein a portion of the access fee is forwarded to the originator associated with the accessed images. FIG. 18 summarizes selected steps of a procedure 1800 for use by the system of FIG. 17 or other suitably equipped devices, systems or apparatus. At 1802, the system inputs images obtained by videocameras mounted within a plurality of vehicles along with identifying information associated with the images that identify, for each image or group of images, where the images were obtained, when the images were obtained and an originator of the images. At 1804, the system stores the identifying information. At 1806, the system provides or allows for selective access to the stored images by an authorized party based on at least some of the identifying information and subject to an access fee, wherein a portion of the access fee is forwarded to the originator associated with the accessed images.

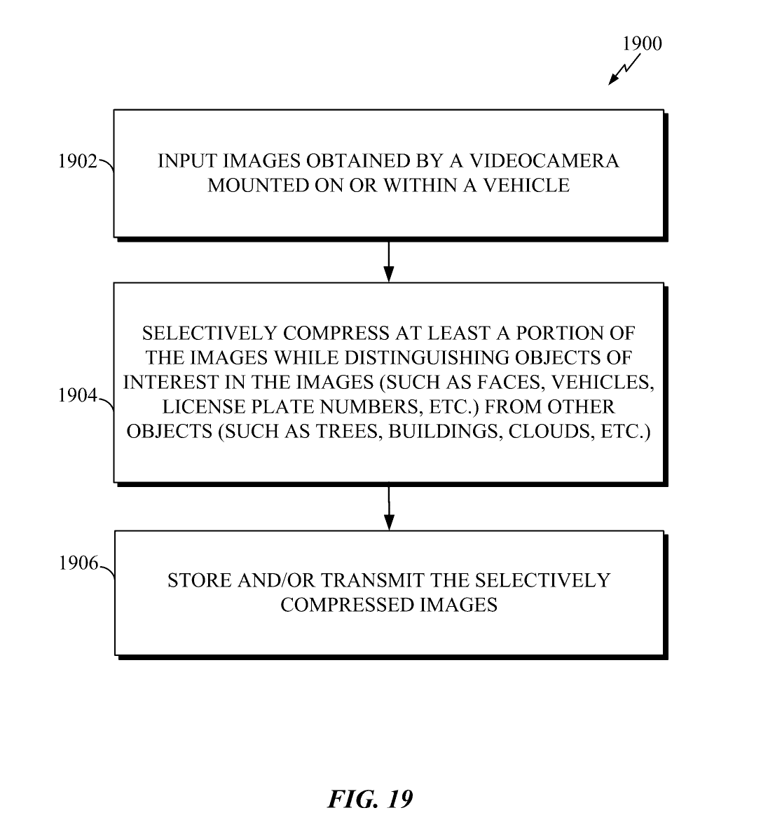

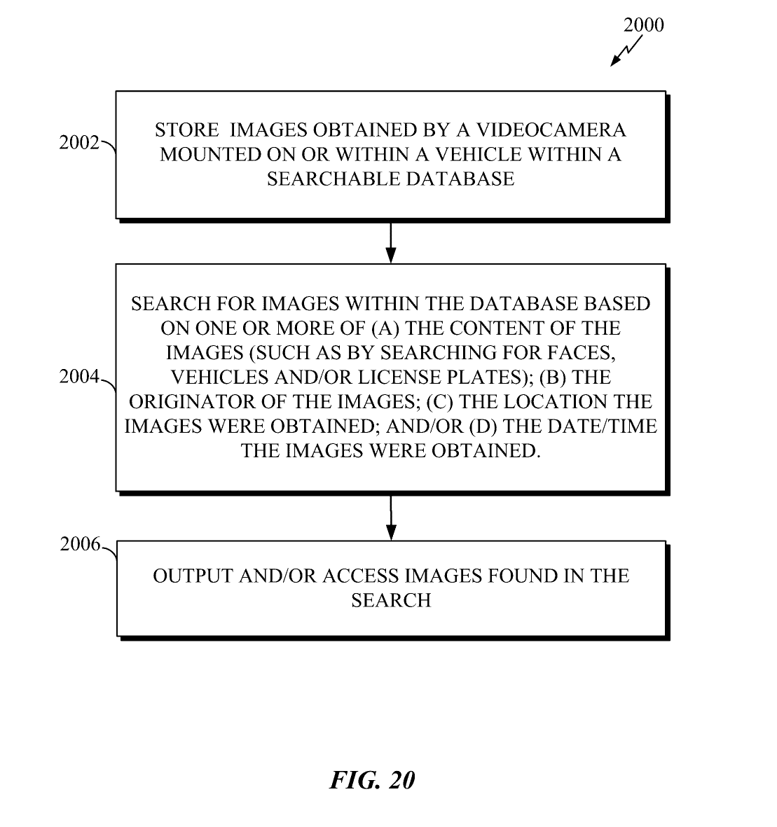

FIG. 19 summarizes selected steps of a procedure 1900 for use by the system of FIG. 15 or other suitably equipped devices, systems or apparatus for selective data compression. At 1902, the system inputs images obtained by a videocamera mounted on or within a vehicle. At 1904, the system selectively compresses at least a portion of the images while distinguishing objects of interest in the images (such as faces, vehicles, license plate numbers, etc.) from other objects (such as trees, buildings, clouds, etc.) At 1906, the system stores and/or transmits the selectively compressed images. FIG. 20 summarizes selected steps of a procedure 2000 for use by the system of FIG. 17 or other suitably equipped devices, systems or apparatus for searching images or other data. At 2002, the system stores images obtained by a videocamera mounted on or within a vehicle within a searchable database. At 2004, the system searches for images within the database based on one or more of (a) the content of the images (such as by searching for particular faces, vehicles and/or license plate numbers); (b) the originator of the images; (c) the location the images were obtained; and/or (d) the date/time the images were obtained. At 2006, the system outputs and/or accesses images found in the search.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of methods and apparatus and many alternatives, modifications, and variations will be apparent to those skilled in the art. Note also that the term “including” as used herein is intended to be inclusive, i.e. “including but not limited to.”

What is claimed is:

1. An apparatus for use with a vehicle, comprising:
a videocamera for obtaining images;
a power connector to connect into a vehicle power source;
an arm for selectively positioning the videocamera; and
a controller mounted along the arm to control operations of the videocamera and to relay power from the power connector to the videocamera.

2. The apparatus of claim 1, wherein the power connector is adapted to connect into one or more of a socket charger power source or a Universal Serial Bus (USB) power source.

3. The apparatus of claim 1, wherein the arm is adapted to selectively position the videocamera with a view of at least some of the surroundings of the vehicle.

4. The apparatus of claim 1, where the controller is further operative to obtain images from the videocamera and output the images to a system external to the vehicle.

5. The apparatus of claim 4, wherein the controller is equipped for one or more of Bluetooth™; Wi-Fi; 3G wireless; or 4G wireless.

6. The apparatus of claim 1, where the controller is further operative to obtain audio signals and output the audio signals to a system external to the vehicle.

7. The apparatus of claim 1, where the controller stores at least a portion of the images obtained from the videocamera for subsequent output to an external system.

8. The apparatus of claim 7, wherein the controller includes a port for receiving one or more of a memory card, a Universal Serial Bus (USB) device or a flash storage device.

9. The apparatus of claim 1, wherein the controller is adapted to be tethered to at least one wireless device positioned on or within the vehicle.

10. The apparatus of claim 1, wherein the controller is further operative to compress at least a portion of the images.

11. The apparatus of claim 10 where the controller is further operative to compress at least a portion of the images while distinguishing objects of interest from other objects.

12. The apparatus of claim 1, further including a Global Positioning System (GPS) device for tracking the location of the vehicle.

13. The apparatus of claim 1, wherein the controller is further operative to obtain additional images from one or more other videocameras mounted on or in the vehicle.

14. The apparatus of claim 1, wherein the controller is further operative to obtain information from an on-board computer of the vehicle.

15. The apparatus of claim 1, wherein two or more videocameras are provided.

16. The apparatus of claim 1, wherein the arm is detachably connected to the controller.

17. The apparatus of claim 1, wherein the apparatus is adapted for use in one or more of a car, truck, aircraft, watercraft, drone, train or motorcycle.

18. The apparatus of claim 1, wherein the controller is operative to control the output of images upon detection of one or more of an impact involving the vehicle, a predicted impact involving the vehicle and an unauthorized access to the vehicle.

19. A system for providing access to images from a plurality of vehicles, comprising:
an input system for inputting images obtained by videocameras within a plurality of vehicles along with identifying information associated with the images that identifies, for each image or group of images, where the images were obtained, when the images were obtained and an originator of the images;
a storage system for storing the identifying information; and
an access system for allowing selective access to the stored images by an authorized party based on at least some of the identifying information and subject to an access fee, wherein a portion of the access fee is forwarded to the originator associated with the accessed images.

20. The system of claim 19, wherein the authorized party is one or more of an insurance company or a law enforcement agency.

21. The system of claim 19, wherein the originator is associated with a particular vehicle from which accessed images were obtained or is associated with a particular videocamera apparatus used to obtained the accessed images.

22. The system of claim 19, wherein the access system includes a search system allowing the authorized party to search for images based on one or more of time, location or originator.

23. The system of claim 19, wherein the access system includes a search system allowing the authorized party to search for images based on the content of the images.

24. The system of claim 23, wherein the content of images to be searched includes one or more of individual faces, individual vehicles or individual license plates recorded in the images.

25. The system of claim 19, wherein at least some of the images are videos streamed from a vehicle.
